(19) United States
(12) Patent Application Publication
(10) Pub. No.: US 2014/0219706 A1
(43) Pub. Date: Aug. 7, 2014

(54) RECORDING MEDIUM INSERTION AND EJECTION DEVICE

(71) Applicant: KABUSHIKI KAISHA TOSHIBA, Minato-ku (JP)

(72) Inventor: Koichiro HANAFUSA, Kanagawa-ken (JP)

(73) Assignee: KABUSHIKI KAISHA TOSHIBA, Minato-ku (JP)

(21) Appl. No.: 14/171,423

(22) Filed: Feb. 3, 2014

Related U.S. Application Data
(63) Continuation of application No. 13/773,830, filed on Feb. 22, 2013, now abandoned.
Application No. 13/773,830 is a continuation of application No. 12/692,993, filed on Jan. 25, 2010, now abandoned.

(30) Foreign Application Priority Data
Mar. 13, 2009 (JP) 2009-061648

(51) Int. Cl. G11B 17/043

(52) U.S. Cl. CPC G11B 17/043
USPC 403/14

(57) ABSTRACT

A recording medium insertion and ejection device which realizes reliable insertion and ejection by simple constitution is provided. The device has a first frame, a second frame, and a latch member provided between the first frame and the second frame. The first frame is inserted in the second frame. Insertion and removal of the medium are performed to the first frame. The latch member guides the first frame to a first position where the recording medium is inserted and removed and a second position where the recording medium is used. If the medium is pushed and inserted in the first frame at the first position, the latch member will guide the first frame to the second position and maintain the first frame at the second position. If the medium is pushed again at this state, the latch member will return the first frame to the first position.

### CROSS REFERENCE TO RELATED APPLICATION

This application is a continuation of application of U.S. application Ser. No. 13/773,830, filed on Feb. 22, 2013, which is a continuation application of U.S. application Ser. No. 12/692,993, filed on Jan. 25, 2010, which is based upon and claims the benefit of priority from the Japanese Patent Application No. 2009-061648, filed on Mar. 13, 2009. The entire contents of the above-identified applications are incorporated herein by reference.

### FIELD OF THE INVENTION

This invention relates to a recording medium insertion and ejection device used for inserting and ejecting a recording media, such as a memory pack.

### DESCRIPTION OF THE BACKGROUND

In general, in a broadcasting apparatus, a recording medium of a card type is inserted in an apparatus body, and an video is recorded on the recording medium. And after recording, the recording medium is ejected from the apparatus body, and the recorded contents are edited. The recording medium is inserted in the apparatus body by a user. However, when the recording medium is ejected from the apparatus body, a method which ejects the recording medium electrically in accordance with the ejection operation is adopted.

In this method which inserts the recording medium to the apparatus body and ejects the recording medium from the apparatus body, when there is no power supply or a drive motor broke down, it becomes difficult to eject the inserted recording medium from the apparatus body.

Accordingly, in order to insert the recording medium of the card type to the apparatus body and eject the recording medium of the card type from the apparatus body, following recording medium insertion and ejection devices are proposed. 1) A recording medium insertion and ejection device which ejects a recording medium to an insertion and taking out position manually by a well known magnet latch of so-called push-to-open type. 2) A recording medium attaching and detaching device which ejects a recording medium to an insertion and taking out position mechanically by a linkage mechanism.

A recording medium insertion and ejection device using a magnet latch is known by Japanese utility model registration No. 2522924, for example. Utility model registration No. 2522924 discloses an optical disk drive apparatus. An optical disc drive unit is capable of moving in an outer case and moving out from the outer case, and takes one position selectively between a disk attaching-detaching position and a disk driving position by the magnet latch.

However, in this recording medium insertion and ejection device, a position which the optical disc drive unit is ejected is the disk attaching-detaching position, i.e., an end position of an ejecting operation. For this reason, the device has a problem that constitution becomes complicated and size becomes large.

And the device has a problem that the optical disc drive unit is ejected when the front of the optical disc drive unit is pressed accidentally in a driving state which the optical disc drive unit is housed in the outer case.

### SUMMARY OF THE INVENTION

An object of the invention is to provide a recording medium insertion and ejection device which is capable of realizing a reliable and secure insertion and ejection operation with simple constitution and whose user-friendliness is improved.

A recording medium insertion and ejection device according to the invention includes a first frame, a second frame and a latch member. The first frame receives a recording medium having a connector at a tip end thereof in free insertion and removal, and has an internal connector to be attached to and detached from the connector of the recording medium. A second frame receives the first frame so that the first frame can slide in an insertion direction and an ejection direction of the recording medium. A latch member is configured to guide the first frame to the second frame to a first position where the recording medium is inserted and ejected and a second position where the recording medium is used. The latch member is also configured that the latch member guides the first frame to the second position and mounts the recording medium to the second position when the recording medium is inserted in the first frame and is pressed in the insertion direction, and that the latch member moves the first frame in the ejection direction, guides the first frame to the second position and ejects the recording medium to the first position when the recording medium mounted is pushed in the insertion direction.

### BRIEF DESCRIPTION OF THE DRAWINGS

FIG. 1 is a perspective view showing appearance constitution of a recording medium insertion and ejection device concerning one embodiment of this invention in a first state;

FIG. 2 is a top view of the recording medium insertion and ejection device in the first state viewed from the top;

FIG. 3 is a side view of the recording medium insertion and ejection device in the first state viewed from a side;

FIG. 4 is a cross sectional view of the recording medium insertion and ejection device taken along a I-I line in FIG. 2;

FIG. 5 is a top view of the recording medium insertion and ejection device in a second state viewed from the top;

FIG. 6 is a side view of the recording medium insertion and ejection device in the second status viewed from the side;

FIG. 7 is a cross sectional view of the recording medium insertion and ejection device taken along a II-II line in FIG. 2; and

FIG. 8 is a perspective view showing an apparatus housing incorporating the recording medium insertion and ejection device shown in FIG. 1.

### DETAILED DESCRIPTION OF THE INVENTION

Hereinafter, embodiments of the invention will be explained in detail in reference to the drawings.

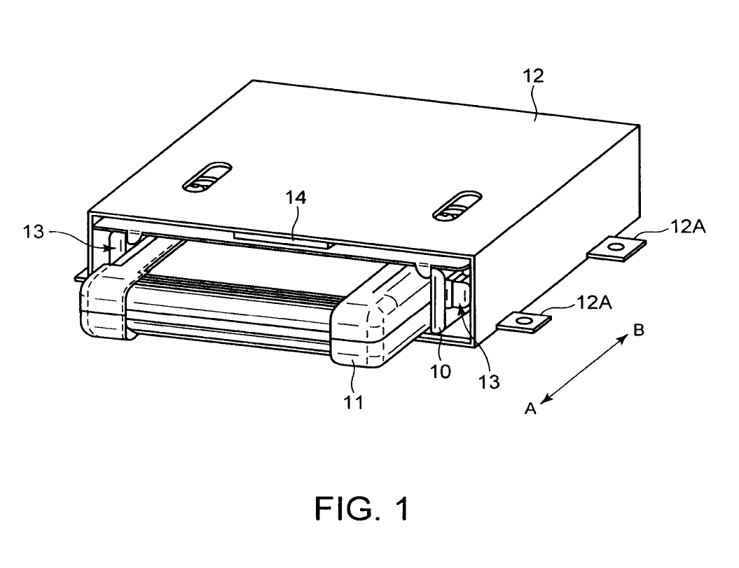

FIG. 1 shows appearance constitution of a recording medium insertion and ejection device concerning one example of the invention. A first frame 10 that constitutes an inner frame is inserted in a second frame 12 that constitutes an outer frame. The second frame 12 is attached to a chassis of a broadcasting apparatus, for example, via attaching part 12A. The first frame 10 is attached to the second frame 12 via guide mechanisms 13 on both sides. Further, a slide member 14 intervenes between the first frame 10 and the second frame 12.

The first frame 10 is guided by the guide mechanisms 13, and is slid in a direction of arrow A (an ejection direction of the recording medium 11) and a direction of arrow B (an insertion direction of the recording medium 11) to the second frame 12. The first frame 10 is slid stably by operation of the slide member 14. As the slide member 14, the material which is excellent in the slide characteristic is used, for example, and a resin material of a polyacetal system is used.

The recording medium 11 is received in the first frame 10 so that the recording medium 11 can be inserted and removed freely. The recording medium 11 is a memory pack and has a memory device, such as a semiconductor memory device and a hard disk drive, inside a box type outer case. Further, a connector 111 for connecting to an outer circuit is provided at the tip of the recording medium 11.

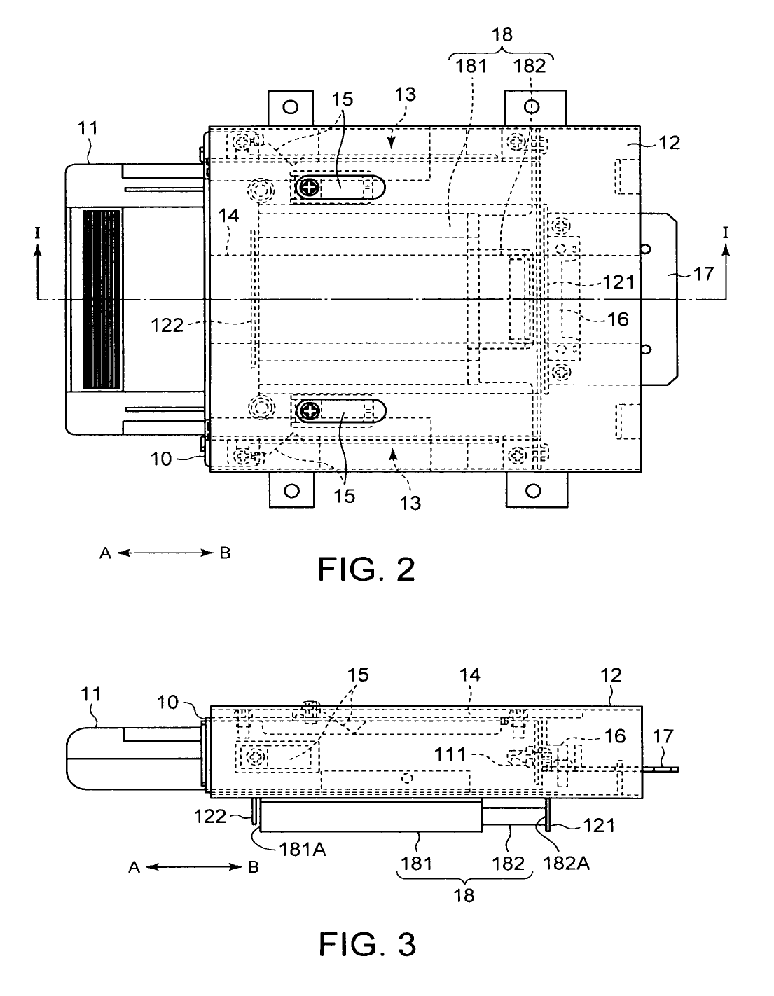

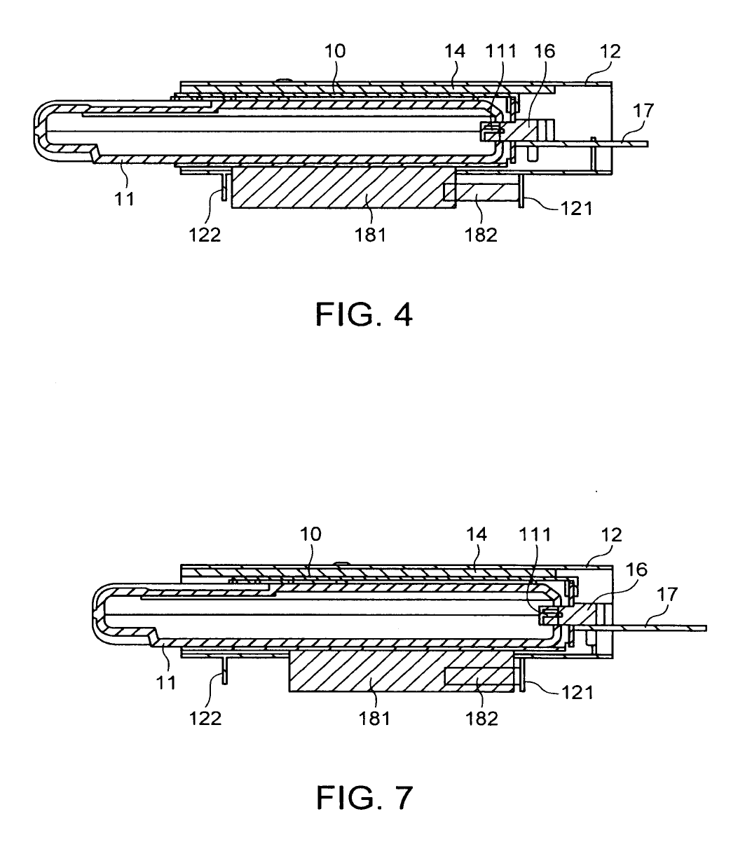

Furthermore, as shown in FIGS. 2,3 and 4, medium presser spring members 15 are attached to the upper surface and both sides of the first frame 10 at one end thereof. The inside of the recording medium 11 is omitted in FIG. 4. The medium presser spring member 15 has a bent part in the other end side. The recording medium 11 is elastically engaged to the bent part of the medium presser spring member 15 so that the recording medium 11 inserted in the first frame 10 can slide to the bent part of the medium presser spring member 15.

In a state that the recording medium 11 is inserted into the first frame 10, a position of the recording medium 11 is controlled to the first frame 10 by spring force of the medium presser spring member 15. Thereby, the recording medium 11 is received in the first frame 10 so that the recording medium 11 can be taken out smoothly.

The first frame 10 is provided with an internal connector 16 which fits to the connector 111 of the recording medium 11. The internal connector 16 is a male connector, and the connector 111 of recording medium 11 is a female connector, for example. The internal connector 16 is electrically connected to an internal circuit of a broadcasting apparatus later mentioned, for example, via a flexible circuit board 17. When the recording medium 11 is mounted to a predetermined position, the connector 111 connects with the internal connector 16.

A latch member is attached to the back of the bottom of the first frame 10 and the back of the bottom of the second frame 12. The latch member includes a magnet latch 18, for example. The magnet latch 18 has a case 181 and a stretch section 182. A part of the stretch section 182 is inserted into the case 181, and the stretch section 182 expands and is contracted. A part of the stretch section 182 is slid in the direction of arrow A and the direction of arrow B, and it can move in and move out to the case 181 freely. If the stretch section 182 is pushed into the case 181 once, the stretch section 182 will be in a contracted state that the stretch section 182 is inserted into the case 181 most, and a latch of the magnet latch 18 is on. If the force to push in is removed, the stretch section 182 will be elongated slightly, but the latch is on, so that the stretch section 182 holds the contracted state. If the stretch section 182 is pushed in again, the latch is released. Then, if the force to push in is removed, the stretch section 182 will expand and be in an extension state that the stretch section 182 projects most from the case 181.

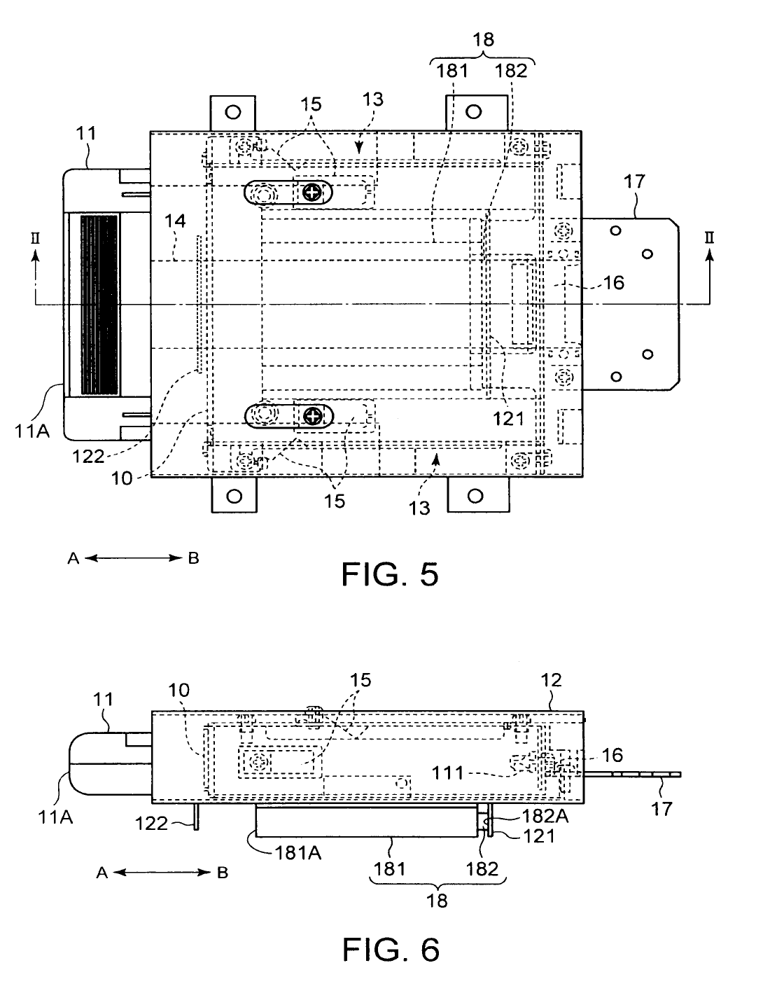

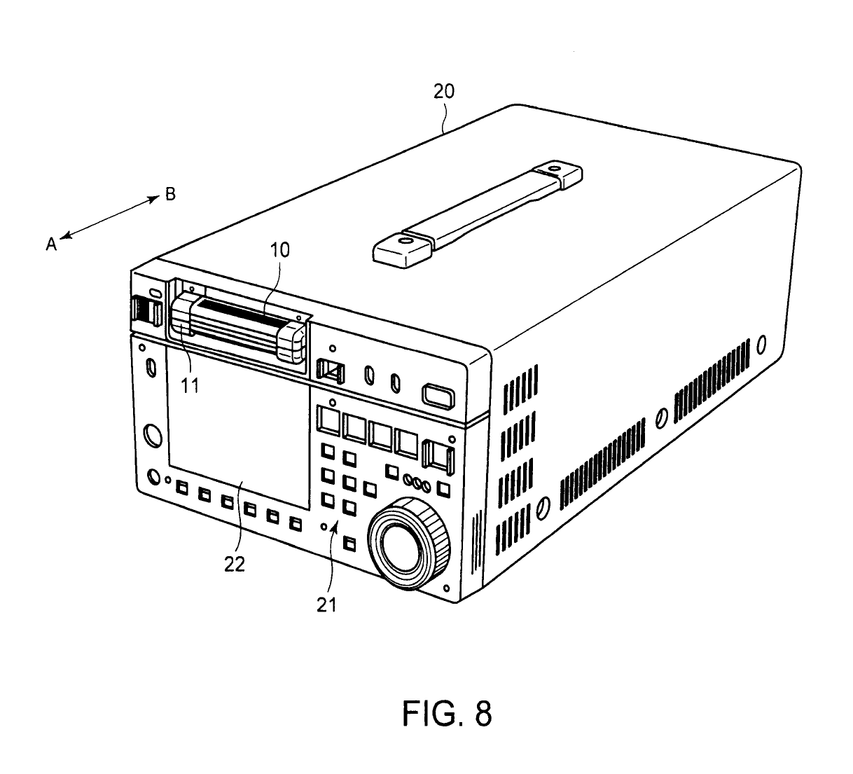

As for the latch member which operates in this way, the case 181 is attached to the first frame 10, and the stretch section 182 is attached to the second frame 11. A tip part 182A of the stretch section 182 is fixed to a first plate 121 formed on the second frame 11. That is, the stretch section 182 is fixed to the second frame 11 via the first plate 121. The case 181 is attached to the first frame 10 in a state that the stretch section 182 is elongated. Further, a second plate 122 is formed in the position where a base end 181A of the case 181 contacts with the second plate 122 in a state that the stretch section 182 is elongated (refer to FIGS. 2,3 and 4). The second plate 122 is formed on the second frame 11. The base end 181A of the case 181 separates from the second plate 122 in a state that the stretch section 182 is contracted (refer to FIGS. 5, 6 and 7). The inside of the recording medium 11 is omitted in FIG. 7. The first plate 121 and second plate 122 are arranged to face each other with a predetermined interval in this way.

In addition, if the first plate 121 is formed with a magnetic material, the tip part 182A of the stretch section 182 of the magnet latch 18 catches the first plate 121 by magnetism, and the stretch section 182 and the first plate 121 are fixed.

According to the state of the stretch section 182 of the latch member, the first frame 10 takes a different position to the second frame 12. Further, according to the position of the first frame 10, the stretch section 182 takes a differed state. When the stretch section 182 expands and the base end 181A of the case 181 contacts with the second plate 122, the first frame 10 is located at a first position where the first frame 10 is most moved in the direction of arrow A and where the recording medium 11 is inserted or is removed (refer to FIGS. 2, 3 and 4). When the stretch section 182 is compressed and the latch is locked, the first frame 10 is located at a second position where the first frame 10 is moved in the direction of arrow B and the recording medium 11 is used (refer to FIGS. 5, 6 and 7). Thus, the latch member is constituted so as to guide the first frame 10 to the second frame 12 to the first position and second position.

Next, operation of the recording medium insertion and ejection device is explained. First, the case that the recoding medium 11 is mounted is explained. The recording medium 11 is inserted in the first frame 10 when the first frame 10 is positioned in the first position (refer to FIGS. 2,3 and 4). If a base end 11A of the recording medium 11 is pushed in the direction of arrow B, the first frame 10 will move in the direction of arrow B to the second frame 12. The case 181 moves in the direction of arrow B with the movement of the first frame 10, and the stretch section 182 contracts so that the stretch section 182 may enter in the case 181.

If the recording medium 11 is further pushed in the direction of arrow B, the stretch section 182 will fully contract and the latch will be on. And the connector 111 of the recording medium 11 is completely connected with the internal connector 16. If the force to push the base end 11A of the recording medium 11 is removed, the first frame 10 will stop at the second position (refer to FIGS. 5, 6 and 7), and the recording medium 11 will be mounted in the recording medium insertion and ejection device. Usually, the recording medium 11 is wrote and read at the second position. At the second position, a part of the recording medium 11 projects from the first frame 10 and second frame 12 so that the base end 11A of the recording medium 11 can be pushed.

Next, the case that the recording medium 11 is removed is explained. When the first frame 10 is located at the second position (refer to FIGS. 5, 6 and 7), the base end 11A of the recording medium 11 is pushed in the direction of arrow B. The first frame 10 moves in the direction of arrow B slightly, the stretch section 182 is compressed slightly, and the latch is released. If the latch is released, the stretch section 182 will expand and project from the case 181. Thereby, the case 181 slides in the direction of arrow A, and the case 181 makes the first frame 10 slide in the direction of arrow A to the second frame 12. The case 181 makes the first frame 10 slide in the direction of arrow A until the base end 181A of the case 181 bumps against the second plate 122. Thereby, the first frame 10 is moved to the first position. In addition, the recording medium 11 moves with the first frame 10 while the connector 111 is connected with the internal connector 16. The base end 10A of the recording medium 10 is exposed from the first frame 10 and second frame 12 at the first position, and the projecting amount at the first position is larger than that at the second position.

As for the magnet latch 18, the tip part 182A of the stretch section 182 is fixed to the first plate 121, and the base end 181A of the case 181 is in contact with the second plate 122. Thereby, as for the case 181 and the first frame 10 attaching the case 181, the slide movement of the direction of arrow A and the direction of arrow B is inhibited. And the exposed part of the recording medium 11 is pinched with fingers, and the recording medium 11 is pulled out in the direction of arrow A at the first position of the first frame 10. Thereby, the connector 111 and the internal connector 16 are separated and the recording medium 11 is taken out from the first frame 10.

FIG. 8 shows an example of a broadcasting apparatus. An operating unit 21 and a display 22 are arranged at the front of the apparatus housing 20. The recording medium insertion and ejection device mentioned above is attached to the apparatus housing 20. The second frame 12 of the recording medium insertion and ejection device is attached to the apparatus housing 20 so that the recording medium 11 can be inserted in and removed from the first frame 10 from the front of the apparatus housing 20.

The recording medium 11 is inserted in the first frame 10 when the first frame 10 is located at the first position. The base end 11A of the recording medium 11 is pushed in the direction of arrow B, and the first frame 10 is pushed in to the second position.

If the first frame 10 is pushed in to the second position, the latch of the magnet latch 18 becomes on, and the connector 111 of the recording medium 11 is connected to the internal connector 16, and mounting of the recording medium 11 is completed (see FIGS. 5, 6 and 7).

When the mounting the recording medium 11 to the recording medium insertion and ejection device has completed as mentioned above, a video is recorded on the recording medium 10 or a video is played back from the recording medium 10 in accordance with the operation to the operating unit 21 of the apparatus housing 20.

When removing the recording medium 11, the base end 11A of the recording medium 11 is pushed so that the recording medium 11 may be pushed in the direction of arrow B. Then, the latch of the magnet latch 18 is released. When the force to push the recording medium 11 is removed, the first frame 10 slides in the direction of arrow A to the second frame 12, and the first frame 10 moves to the first position (see FIGS. 2, 3 and 4).

When the first frame 10 is located at the first position, the stretch section 182 is fixed to the first plate 121 and the base end of the case 181 contacts with the second plate 122, so that the slide movement of the first frame 10 to the direction of arrow A and the direction of arrow B is restricted. Where the movement of the first frame 10 is restricted, the user pinches the exposed part of the recording medium 11 exposed from the apparatus housing 20 with his/her fingers and pulls out the recording medium 11 to remove the recording medium 11 from the first frame 10. In this removal, the connector 111 is pulled out from the internal connector 16.

As for the recording medium insertion and ejection device, if the recording medium 11 is accidentally pressed in the direction of arrow B in a state that the recording medium 11 is mounted, the latch of the magnet latch 18 will be released. And the first frame 10 moves to the first position, and the recording medium 11 is ejected. However, since the connector 111 of the recording medium 11 is connected with the internal connector 16, unless the user takes out the recording medium 11, the recording medium 11 maintains a state that the recording medium 11 is positioned and received by the first frame 10.

Accordingly, the recording medium 11 does not drop out from the first frame 10 to a floor and is not damaged. For this reason, the recording medium insertion and ejection device can perform the reliable insertion and removal of the recording medium 11 without being affected by the using position etc. of the broadcasting apparatus. Thereby, the recording medium insertion and ejection device can handle the recording medium 11 safely.

Furthermore, unless the user removes the recording medium 11, the connector 111 of the recording medium 11 remains electrically connected to the internal connector 16. Therefore, even if the recording medium 11 is accidentally ejected to the first position of the first frame 10, processing, such as recording of the image to the recording medium 11 or playback of the image from recording medium 11, can be continued. Even if the recording of the image or the playback of the image, etc. is under execution, the first frame 10 at the first position moves to the second position when the recording medium 11 is pushed in the direction of arrow B.

According to the invention, a motor for moving the recording medium is unnecessary, a secure insertion and removal of the recording medium 11 can be performed easily by a simple constitution, and the recording medium insertion and ejection device which improves user-friendliness can be provided. Further, even if the incorrect ejection of the recording medium 11 is caused by an operation mistake, the recording medium insertion and ejection device does not affect the operation to the recording medium 11.

The invention is not limited to the above arrangement and can constitute various kinds of combination arrangement. For example, in the embodiment, the latch member includes the magnet latch 18, the tip of the stretch section 182 catches the first plate 121 by magnetism, and thereby the stretch section 182 is fixed to the first plate 121. However, without using a magnet for the latch member 18, the tip of the stretch section 182 may be fixed to the first plate 121 by adhesive etc.

In the embodiment, the case 181 of the magnet latch 18 is fixed to the first frame 10, and the tip of the stretch section 182 is fixed to the second frame 12 via the first plate 121. However, a modification in which the case 181 is fixed to the second frame 12, the tip of the stretch section 182 is fixed to the first frame 10, and the stretch section 182 projects in the direction of arrow A from the case 181, is possible.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A recording medium insertion and ejection device, comprising:
a first frame to receive a recording medium having a connector at a tip end thereof in free insertion and removal, and the first frame having an internal connector to be attached to and detached from the connector of the recording medium;
a second frame receiving the first frame so that the first frame can slide in an insertion direction and an ejection direction of the recording medium;
a latch member configured to guide the first frame to the second frame to a first position where the recording medium is inserted and ejected and a second position where the recording medium is used, and the latch member being configured that the latch member guides the first frame to the second position and mounts the recording medium to the second position when the recording medium is inserted in the first frame and is pressed in the insertion direction, and that the latch member moves the first frame in the ejection direction, guides the first frame to the second position and ejects the recording medium to the first position when the recording medium mounted is pushed in the insertion direction; and
a slide member which intervenes between the first frame and the second frame, wherein the recording medium has a base end which is exposed from the first frame and the second frame, so as to be pushed in a state that the recording medium is mounted at the second position,
the connector of the recording medium is connected to the internal connector when the recording medium is mounted at the second position, and
the recording medium is ejected to the first position in a state that the connector is being connected to the internal connector when the recording medium mounted at the second position is pushed in the insertion direction.

2. The recording medium insertion and ejection device according to claim 1, wherein the latch member includes a case fixed to the first frame, and a stretch section being configured to move in the case and move out from the case and one end portion of the stretch section is fixed to the second frame, wherein
when the force to the insertion direction is given to the first frame, the stretch section is compressed, maintains a compression state, and maintains the first frame at the second position, and
when the force to the insertion direction is given to the first frame again, the compression state of the stretch section is released, and the stretch section expands and moves the first frame in the ejection direction.
